(19) United States
(12) Patent Application Publication
(10) Pub. No.: US 2004/0122883 A1
(43) Pub. Date: Jun. 24, 2004

(54) High speed add-compare-select circuit for radix-4 Viterbi decoder

(76) Inventors: Seok-Jun Lee, Savoy, IL (US); Manish Goel, Dallas, TX (US)

Correspondence Address: TEXAS INSTRUMENTS INCORPORATED, P O BOX 655474, M/S 3999, DALLAS, TX, 75265

(21) Appl. No.: 10/322,876

(22) Filed: Dec. 18, 2002

(51) Int. Cl. G06F 7/38

(52) U.S. Cl. 708/490

(57) ABSTRACT

A high speed add-compare-select (ACS) circuit for a radix-4 Viterbi decoder has a lower critical path delay than that achievable using a traditional ACS circuit suitable for use with a radix-4 Viterbi decoder. The high speed ACS circuit is implemented to achieve a lower critical path delay without increasing the clock rate beyond that required by a radix-2 ACS circuit.

### BACKGROUND OF THE INVENTION

1. Field of the Invention

This invention relates generally to Viterbi decoders. More particularly, this invention relates to a high speed add-compare-select (ACS) circuit for a radix-4 Viterbi decoder.

2. Description of the Prior Art

A Viterbi decoder performs an optimum decoding of convolutionally encoded digital sequences. It is widely used in digital communication systems with data rates ranging from few kbps in narrowband applications to several hundreds of Mbps in broadband applications like Wireless LAN.

As shown in FIG. 1, a Viterbi decoder 100 is comprised of three units: a branch-metric computation unit (BMU) 102, an add-compare select unit (ACSU) 104 and a survivor path memory unit (SMU) 106. The input data is used in the BMU 102 to calculate the set of branch metrics for each new time step. These metrics are then fed to the ACSU 104 that accumulates the branch metrics recursively as path metrics according to the trellis determined by a convolutional encoder polynomial. The SMU 106 processes the decisions being made in the ACSU 104 and outputs an estimated path, with a latency of trace-back depth.

It is clear that ACSU 104 and SMU 106 architectures depend only on the trellis and hence these two units are independent of the application for which a Viterbi decoder is being used. The application specific computations are done in the BMU 102 according to soft input definition; and the interpretation of the decoded path into data at the output of the SMU 106 is also dependent upon the output format definition. Since the application specific parts of a Viterbi decoder are mainly found at the input and output, the high speed architecture of ACSU 104 can be generally applicable.

If a high speed Viterbi decoder needs to be implemented for broadband applications with greater than 100 Mbps data rates, the critical path of a Viterbi decoder must be minimized. By looking at the block diagram of a Viterbi decoder 100 in FIG. 1, it is obvious that the BMU 102 as well as the SMU 106 are purely feedforward and the throughput can easily be increased by massive pipelining. However, this does not hold for the ACSU 104.

One way to improve the throughput of ACSU 104 is to apply a look-ahead scheme (radix-4 architecture) to the trellis 200 as shown in FIG. 2. A radix-4 architecture achieves a double data rate without increasing the clock rate because a radix-4 architecture can run at the clock rates employed by a radix-2 architecture. The circuit complexity associated with a conventional radix-4 architecture is greater however, as can be seen with reference to FIG. 3 and FIG. 4, where a conventional radix-4 ACSU 400 basically requires 2-stage comparison circuits including 4 more adders and 2 more multiplexers than that required by a conventional radix-2 ACSU 300 shown in FIG. 3.

In view of the foregoing, it is both advantageous and desirable to provide an ACS circuit for a radix-4 Viterbi decoder that has a lower critical path delay than that achievable using a traditional ACS circuit suitable for use with a radix-4 Viterbi decoder. It is also advantageous and desirable to implement such a lower critical path delay without increasing the clock rate beyond that required by a radix-2 ACS circuit.

### SUMMARY OF THE INVENTION

The present invention is directed to a high speed add-compare-select (ACS) circuit for a radix-4 Viterbi decoder. The high speed radix-4 Viterbi decoder ACS has a lower critical path delay than that achievable using a traditional ACS circuit suitable for use with a radix-4 Viterbi decoder. The high speed ACS circuit is implemented to achieve a lower critical path delay without increasing the clock rate beyond that required by a radix-2 ACS circuit.

According to one embodiment, a high speed add-compare-select circuit comprises a first plurality of adders configured to add a plurality of distinct metrics and generate a plurality of outputs therefrom; a second plurality of adders configured to generate a plurality of most significant bits in response to the plurality of outputs; control signal generation logic configured to determine at least one path metric in response to the plurality of most significant bits; and a selector element configured to generate the next path metric in response to the at least one path metric and further in response to the plurality of outputs.

According to another embodiment, a method of processing a plurality of distinct metrics and generating a subsequent path metric therefrom comprises the steps of providing a high speed add-compare-select (ACS) circuit, a branch metric computation unit, and a survivor path memory unit configured as a radix-4 Viterbi decoder having a radix-2 Viterbi clock rate; adding a plurality of distinct branch and path metrics and generating a plurality of outputs therefrom; generating a plurality of most significant bits in response to the plurality of outputs; determining a minimum or maximum path metric in response to the plurality of most significant bits; and generating the next path metric in response to the minimum or maximum path metric and further in response to the plurality of outputs, such that a data rate substantially twice that of a conventional radix-4 Viterbi decoder is achieved via the radix-2 Viterbi decoder clock rate.

### BRIEF DESCRIPTION OF THE DRAWINGS

Other aspects and features of the present invention and many of the attendant advantages of the present invention will be readily appreciated as the same become better understood by reference to the following detailed description when considered in connection with the accompanying drawings wherein:

FIG. 1 is a system block diagram illustrating a conventional Viterbi decoder;

FIG. 2 is a diagram illustrating a radix-4 trellis for K=3,4 states;

FIG. 3 is a circuit diagram illustrating a conventional radix-2 add-compare-select circuit;

FIG. 4 is a circuit diagram illustrating a conventional radix-4 add-compare-select circuit;

FIG. 5 is a circuit diagram illustrating a high speed add-compare-select circuit according to one embodiment of the present invention; and

FIG. 6 is a circuit diagram illustrating a high speed add-compare-select circuit according to another embodiment of the present invention.

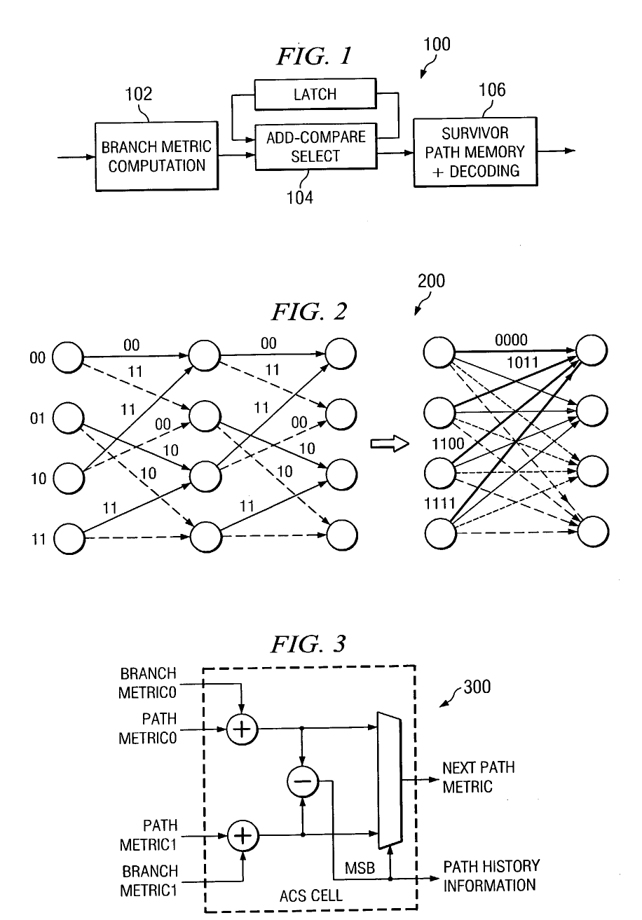

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

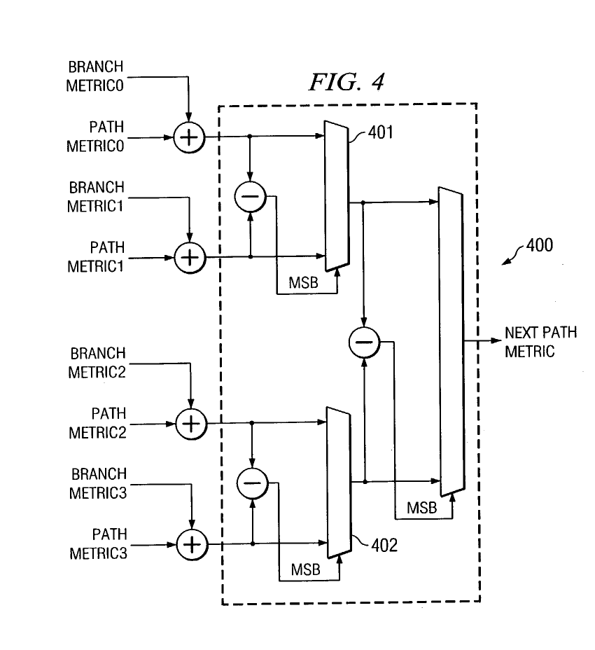

Looking again at FIG. 4, a conventional add-compare-select (ACS) circuit 400 comprises two cascaded comparators 402, 404 in order to select one minimum or maximum path metric out of four possible candidates. This circuit 400 requires 7 adders, and has 3 adders and two multiplexers contributing to its critical path delay.

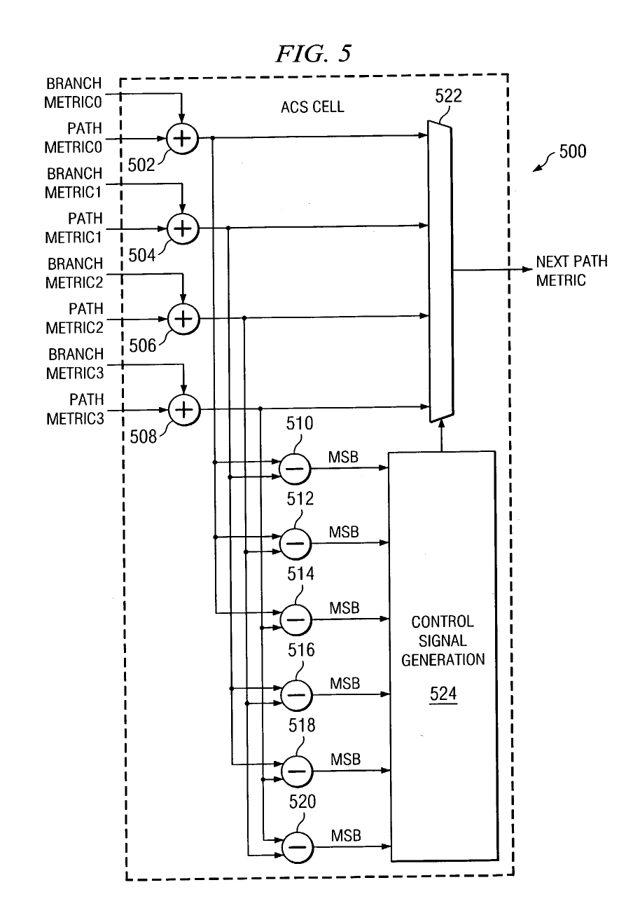

FIG. 5 shows a high speed add-compare-select circuit 500 that employs 10 adders 502-520 and one 4-input multiplexer 522. At the cost of 3 more adders, it is intuitively obvious that the critical path delay is determined by 2 adders and a control signal generation block 524. Importantly, the logic delay of the control signal generation block 524 must be small because it determines the minimum or maximum path metric depending on 4 most significant bits (MSB) in the following manner.

Assuming

A=path metric0+branch metric0

B=path metric1+branch metric1

C=path metric2+branch metric2

D=path metric3+branch metric3

then

X1=MSB{A−B}

X2=MSB{A−C}

X3=MSB{A−D}

X4=MSB{B−C}

X5=MSB{B−D}

X6=MSB{C−D}

where, MSB{A−B} operator is equal to the MSB of A−B; and it is also known that A is less than B if MSB{A−B} is equal to one. Thus, the 4-input multiplexer 522 requires the truth table described herein below.

If (X1=1 and X2=1 and X3=1), then A must be selected.

If (˜X1=1 and X4=1 and X5=1), then B must be selected.

Else, If (˜X2=1 and ˜x4=1 and X6=1), then C must be selected.

Else, then D must be selected.

The control signal generation logic associated with ACS circuit 500 therefore reduces the critical path hardware requirements by one adder, desirably reducing the critical path delay.

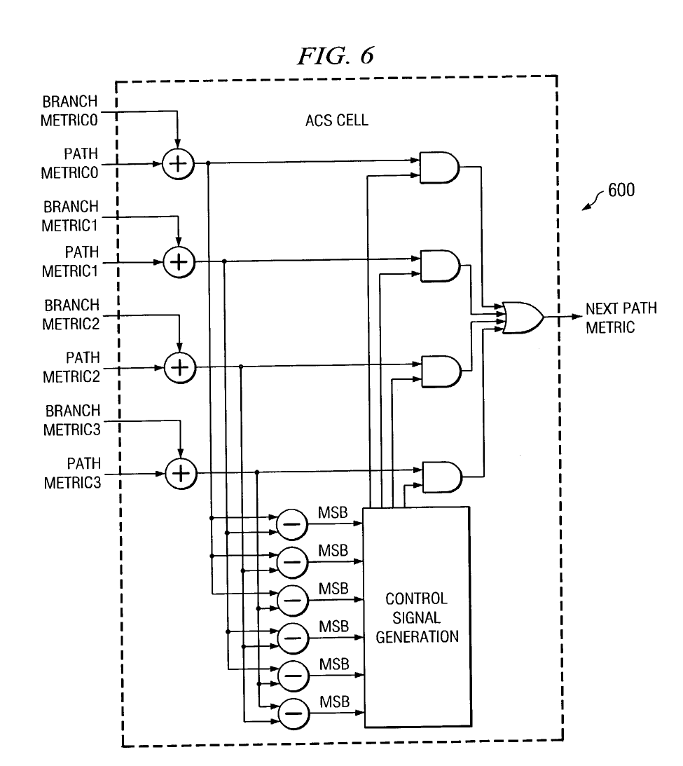

FIG. 6 shows a high speed ACS circuit 600 according to another embodiment of the present invention. ACS circuit 600 employs four 2-input AND gates and a 4-input OR gate instead of a 4-input multiplexer such as seen in high speed ACS circuit 500 discussed herein before. High speed ACS circuit 600 also reduces the ACS circuit critical path delay at the cost of three more adders and the control signal generation logic block 524.

The present inventors implemented a K=7 (64-state) Viterbi decoder using verilog language. The Viterbi decoder was then synthesized using a field programmable gate array (FPGA) to achieve the results shown in Table 1 below.

TABLE 1
Synthesis Results for Viterbi Decoder Using FPGA

| | | Speed after | Logic usages (number |
|---|---|---|---|
| Circuit | Speed after synthesis | place & route | of used slices) |
| | 81.5 MHz | 67.899 MHz | 30% |
| | 91.9 MHz | 79.523 MHz | 36% |
| | 91.9 MHz | 79.994 MHz | 39% |

In summary explanation of the above, a conventional radix-4 ACS circuit is reformulated to implement a high speed add-compare-select (ACS) circuit for a radix-4 Viterbi decoder. The high speed radix-4 Viterbi decoder ACS has a lower critical path delay than that achievable using a traditional ACS circuit suitable for use with a radix-4 Viterbi decoder. The high speed ACS circuit is implemented to achieve a lower critical path delay without increasing the clock rate beyond that required by a radix-2 ACS circuit.

In view of the above, it can be seen the present invention presents a significant advancement in the art of Viterbi decoders. Further, this invention has been described in considerable detail in order to provide those skilled in the Viterbi decoding art with the information needed to apply the novel principles and to construct and use such specialized components as are required.

Further, in view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow. Since for example, the ACS architecture is not based on the particular encoder, and since only the ACS path recursion is dependent upon the trellis, the concepts discussed herein before with reference to particular ACS embodiments are applicable to ASIC and FPGA implementations of Viterbi decoders regardless of encoders employed.

What is claimed is:

1. A high speed add-compare-select circuit comprising:
a first plurality of adders configured to add a plurality of distinct metrics and generate a plurality of outputs therefrom;
a second plurality of adders configured to generate a plurality of most significant bits in response to the plurality of outputs;
control signal generation logic configured to determine at least one path metric in response to the plurality of most significant bits; and
a selector element configured to generate the next path metric in response to the at least one path metric and further in response to the plurality of outputs.

2. The high speed add-compare-select circuit according to claim 1 wherein the selector element comprises a multi-input comparator.

3. The high speed add-compare-select circuit according to claim 1 wherein the selector element comprises:
a plurality of AND gates configured to selectively combine the plurality of outputs with the at least one path metric and generate a plurality of logic signals therefrom; and
an OR gate configured to generate the next path metric in response to the plurality of logic signals.

4. The high speed add-compare-select circuit according to claim 1 wherein the first plurality of adders configured to add a plurality of distinct metrics and generate a plurality of outputs therefrom comprises four adders configured to selectively add the plurality of distinct metrics and generate four outputs therefrom.

5. The high speed add-compare-select circuit according to claim 4 wherein the second plurality of adders configured to generate a plurality of most significant bits in response to the plurality of outputs comprises six adders configured to selectively add the four outputs and generate six most significant bits therefrom.

6. The high speed add-compare-select circuit according to claim 5 wherein the control signal generation logic configured to determine at least one path metric in response to the plurality of most significant bits comprises control signal generation logic configured to determine a minimum or maximum path metric in response to the six most significant bits.

7. The high speed add-compare-select circuit according to claim 1 further comprising:
a branch metric computation unit; and
a survivor path memory unit, wherein the branch metric computation unit, survivor path memory unit, first and second plurality of adders, control signal generation logic, and selector element are configured as a radix-4 Viterbi decoder.

8. A method of processing a plurality of distinct metrics and generating a subsequent path metric therefrom, the method comprising the steps of:
providing a high speed add-compare-select (ACS) circuit, a branch metric computation unit, and a survivor path memory unit configured as a radix-4 Viterbi decoder having a radix-2 Viterbi clock rate;
adding a plurality of distinct branch and path metrics and generating a plurality of outputs therefrom;
generating a plurality of most significant bits in response to the plurality of outputs;
determining a minimum or maximum path metric in response to the plurality of most significant bits; and
generating the next path metric in response to the minimum or maximum path metric and further in response to the plurality of outputs, such that a data rate substantially twice that of a conventional radix-4 Viterbi decoder is achieved via the radix-2 Viterbi decoder clock rate.
